(19) United States
(12) Patent Application Publication
(10) Pub. No.: US 2023/0398624 A1
(43) Pub. Date: Dec. 14, 2023

(54) DEVICE FOR MEASURING THE WELDING FORCE AND DETECTING THE ELECTRICAL WELDING VOLTAGE DURING A WELDING PROCESS OF A RESISTANCE WELDING DEVICE

(71) Applicant: Kistler Holding AG, Winterthur (CH)

(72) Inventors: Andri Lehmann, Neuhausen am Rheinfall (CH); Davorin Konic, Hüttikon (CH); Stefan Koch, Hettlingen (CH)

(21) Appl. No.: 18/330,394

(22) Filed: Jun. 7, 2023

(30) Foreign Application Priority Data
Jun. 8, 2022 (EP) 22150765.0

(51) Int. Cl. B23K 11/25; B23K 11/31; B23K 11/11

(52) U.S. Cl. CPC B23K 11/255; B23K 11/314; B23K 11/115; B23K 11/258

(57) ABSTRACT

A device for measuring a welding force and for detecting a welding voltage during a welding process of a resistance welding device, which resistance welding device includes a welding gun with two electrode arms, includes two contact sockets for placing the device at the electrode arms. A sensor element is included for measuring the welding force exerted by the electrode arms during a welding process. A component is included and configured and disposed for detecting the welding voltage during the welding process. A coupling element is configured and disposed so that when the device is placed at the electrode arms, the coupling element mechanically couples the device to the resistance welding device.

### TECHNICAL FIELD

The invention relates to a simulation device for measuring the welding force and for detecting the electrical welding voltage during a welding process of a resistance welding device.

### BACKGROUND OF THE INVENTION

Resistance welding devices can be used for welding metallic workpieces such as sheet metals, etc. Such resistance welding devices find applications in welding robots and are widely used in the metalworking industry. Generally, a resistance welding device comprises a welding gun having two electrode arms. At least one of the electrode arms is designed to be movable while the other of the electrode arms may be stationary. The welding gun can be opened and closed by moving the movable electrode arm. Workpieces are positioned between the electrode arms in the opened welding gun; and the workpieces are subjected to a welding force of several kN when the welding gun is closed. The magnitude of the welding force, the magnitude of the electrical welding current and the magnitude of the electrical welding voltage during the welding process are predefined. In general, the welding process is not started until the workpieces have been subjected to a minimum welding force of 90% of the welding force. Afterwards, the workpieces are welded in the welding process by an electrical welding current of several 10 kA at an electrical welding voltage of several V.

For a consistently high quality of the welding process, a device measures the welding force acting during the welding process and detects the electrical welding voltage applied during the welding process. This measurement and detection are documented at regular intervals. Furthermore, this measurement and detection can be used to determine whether the welding gun requires maintenance.

A device of the aforementioned type for measuring the welding force and detecting the electrical welding voltage during the welding process of a resistance welding device that is named welding force calibration transmitter type 9831C is commercially available from the applicant and described in instruction manual No. 9831C_002.567d-04.11. This device comprises a handle with two contact sockets. The device is held at the handle by a human operator, and by the contact sockets the device is introduced between the electrode arms in place of the workpieces.

The device comprises a piezoelectric sensor element that generates electrical polarization charges under the action of the welding force. The number of the electrical polarization charges is proportional to the magnitude of the welding force. The electrical polarization charges are used to measure the welding force. The device comprises a charge amplifier unit that amplifies the electrical polarization charges to give electrical DC voltages.

The device comprises a component that detects the electrical welding voltage applied between the electrode arms.

However, there is the desire in the metalworking industry to operate such a device without an operator having to be physically present. Particularly, for reasons of safety welding robots operating together with a human operator should be physically separated by means of a safety device.

Moreover, a human operator holding the device for the purpose of measuring the welding force and for detecting the electrical welding voltage during the welding process will introduce vibrations and bending moments into the device over the handle, which vibrations and bending moments may distort the measurement of the welding force and the detection of the electrical welding voltage during the welding process. To resolve this problem, the measurements and detections are repeated multiple times to obtain a statistical mean of the measured values, thus, reducing the impact of the distortion by vibrations and bending moments on the accuracy of the measurements and detections. However, carrying out multiple repetitions of the welding force measurement and the electrical welding voltage detection during the welding process is time-consuming and, thus, expensive.

### OBJECTS AND SUMMARY OF THE INVENTION

Therefore, it is an object of the present invention to disclose a device for measuring the welding force and for detecting the electrical welding voltage during a welding process of a resistance welding device that can be operated autonomously without the presence of a human operator, that enables welding force and electrical welding voltage detection during the welding process with high accuracy, and that performs the measurement of the welding force and the detection of the electrical welding voltage during the welding process in an easy, quick and cost-effective manner.

This object and others has been achieved by the features described hereinafter.

The present invention relates to a device for measuring the welding force and for detecting the electrical welding voltage during a welding process of a resistance welding device, which resistance welding device comprises a welding gun with two electrode arms; comprising two contact sockets for placing the device at the electrode arms; comprising at least one sensor element for measuring the welding force exerted by the electrode arms during a welding process; and comprising at least one component for detecting the electrical welding voltage during the welding process; wherein the device comprises coupling means, and when the device is placed at the electrode arms said coupling means mechanically couples the device to the resistance welding device.

Due to this mechanical coupling of the device to the resistance welding device by means of the coupling means of the invention it is no longer necessary that the device is held by a human operator for measuring the welding force and detecting the electrical welding voltage during a welding process. This mechanical coupling may be accomplished easily and quickly and enables autonomous operation of the device. Further, since holding by the human operator is no longer necessary, no vibration and bending moments are introduced into the device, thus, increasing the accuracy of the measurement of the welding force and the detection of the electrical welding voltage during the welding process.

Advantageous embodiments of the invention are described hereinafter.

In an advantageous embodiment, the two electrode arms comprise a lower electrode arm and an upper electrode arm; wherein the two contact sockets comprise a lower contact socket and an upper contact socket; wherein the lower contact socket comprises a lower conical recess, and when the device is placed at the electrode arms said lower conical recess accommodates a foremost tip of the lower electrode arm and centers it with respect to a vertical axis; and wherein for mechanically coupling the device to the resistance welding device the coupling means exerts a coupling force onto the resistance welding device.

Thus, the coupling means exerts a coupling force onto the resistance welding device for mechanically coupling the device to the resistance welding device. This exerting of a coupling force can be achieved easily and quickly and enables autonomous operation of the device.

In an advantageous embodiment, the coupling means comprises a coupling body, which coupling body is attached to the lower contact socket on the outside thereof; wherein the coupling body comprises a coupling opening, which coupling opening extends through the coupling body along the vertical axis and communicates with the lower conical recess; wherein, when the device is placed at the electrode arms, the lower electrode arm protrudes through the coupling opening; and wherein for mechanically coupling the device to the resistance welding device the coupling means applies the coupling force onto the lower electrode arm in the coupling opening.

Thus, the device easily accomplishes mechanical coupling to the lower electrode arm that already protrudes through a coupling opening of the coupling means after the device has been placed at the electrode arms. In addition, accomplishing the mechanical coupling is easy and quick enabling the device to operate autonomously.

In an advantageous embodiment, the coupling means comprises a clamping member, which clamping member surrounds the coupling opening in a radial direction; wherein the clamping member comprises a first clamping member end and a second clamping member end, said first and second clamping member ends being spaced apart from each other by a gap along; and wherein the coupling force is exerted onto the lower electrode arm by reducing the width of said gap.

Thus, it is a clamping member comprising two clamping member ends spaced apart from each other by a gap that exerts the coupling force by reducing the width of the gap which can be accomplished in an easy and quick manner and enables autonomous operation of the device.

In an advantageous embodiment, the coupling means comprises a clamping means, which clamping means is arranged at the clamping member; wherein the clamping means comprises a bushing member and a screw member; wherein the bushing member is attached to the first clamping member end and holds the screw member; and wherein the screw member can be screwed into the second clamping member end thereby reducing the width of the gap.

Such screwing-in of a screwing means into a second clamping member end for reducing the width of the gap can be accomplished in an easy and quick manner and enables autonomous operation of the device.

In another advantageous embodiment, a retaining member is arranged in the coupling opening; wherein, when the device is placed at the electrode arms, the lower electrode arm protrudes through the coupling opening and compresses the retaining member; and wherein the compressed retaining member exerts the coupling force onto the lower electrode arm.

Arranging a compressible retaining member in the coupling opening, wherein said retaining member in the compressed state exerts the coupling force onto the lower electrode arm, can be done easily and quickly and enables the device to operate autonomously.

In another advantageous embodiment, the resistance welding device comprises a support; wherein the device after having been placed at the electrode arms can be mechanically coupled to the support; wherein the coupling means consists of a further fastening means; and wherein the further fastening means exerts the coupling force onto the support for achieving the mechanical coupling of the device to the resistance welding device.

Such a mechanical coupling of a coupling means that merely consists of a further fastening means to a support of the resistance welding device can also be accomplished easily and quickly and enables autonomous operation of the device.

In another advantageous embodiment, the device comprises a lower housing part, an upper housing part and an insulator; wherein the two contact sockets consists of a lower contact socket and an upper contact socket; wherein the lower contact socket is attached to the lower housing part on the outside thereof; wherein the upper contact socket is attached to the upper housing part on the outside thereof; wherein the insulator electrically insulates the lower housing part from the upper housing part; the lower housing part and the upper housing part being mechanically connected to each other by the insulator; wherein, when connected to each other, the lower housing part, the upper housing part and the insulator enclose at least one interior space; and wherein the sensor element and the component are arranged in the interior space.

The device comprises a three-part housing formed by a lower housing part, an upper housing part and an insulator and which accommodates in an interior space the sensor element and the two electrodes. The two contact sockets are attached to the outside of the lower housing part and the upper housing part and transmit the welding force to be measured to the sensor element arranged in the interior space. Placing such a three-part housing at the electrode arms is accomplished easily and quickly enabling autonomous operation of the device. Thereby, the insulator electrically insulates the lower housing part from the upper housing part so that the electrical welding current of several 10 kA cannot flow through the three-part housing and distort the measurement of the welding force by the sensor element which is what enables the welding force to be measured accurately in the first place.

In another advantageous embodiment, the sensor element is arranged in the interior space to lie in the main force path of the welding force.

Since the sensor element is arranged in the main force path, substantially the entire welding force acts onto the sensor element resulting in high sensitivity of the sensor element. For the purposes of the present invention, the term “sensitivity” denotes the ratio of the force values that the sensor element generates under the action of the welding force and the magnitude of the actual welding force. The sensor element having this amount of sensitivity exhibits a low response threshold of less than/equal to 0.02N for the welding force to be measured so that it is able to measure even a small welding force with high accuracy.

In another advantageous embodiment, the device comprises a first sensor element, a second sensor element, and a third sensor element; wherein the three sensor elements are identical single-component force transducers that measure the same welding force acting along the vertical axis; and wherein the three sensor elements generate force values for the welding force measured.

Single-component force transducers are inexpensive as compared to multi-component force transducers. Using three identical single-component force transducers in the device leads to a three-fold increase in the measuring range for measuring the welding force to be measured as compared to a device that comprises only one single-component force transducer which further increases the accuracy of the welding force measurement.

In another advantageous embodiment, the first sensor element is arranged in a first interior space, the second sensor element is arranged in a second interior space, and the third sensor element is arranged in a third interior space; wherein the three sensor elements are arranged in a horizontal plane, perpendicular to a vertical axis; wherein the three sensor elements are arranged at an equal distance from the vertical axis in a radial direction; and wherein the three sensor elements are equally spaced apart from each other at an angle of 120°.

This symmetrical arrangement with respect to the longitudinal axis of three sensor elements in three internal spaces substantially avoids the occurrence of bending moments, which bending moments unilaterally act upon the device in the horizontal plane and falsify the welding force that acts along the vertical axis, thus, increasing the accuracy of the welding force measurement.

In another advantageous embodiment, the component is arranged in a fourth interior space; wherein the component comprises a lower electrode, an upper electrode, and an optocoupler; wherein the lower electrode is attached to the inside of the lower housing part; wherein the upper electrode is attached to the inside of the upper housing part; and wherein the optocoupler detects an electrical welding voltage applied between the lower electrode and the upper electrode and converts it into measured values.

The component comprises two electrodes and an optocoupler for detecting the electrical welding voltage applied between the lower housing part and the upper housing part during the welding process and converting it into measured values. Such an optocoupler is inexpensive and has galvanically isolated inputs and outputs. In this way, the electrical welding voltage having a magnitude of several V cannot enter the three-part housing and distort the measurement of the welding force by the sensor element, thus, enabling an accurate measurement of the welding force.

In a further advantageous embodiment, the device comprises an evaluation unit for evaluating the force values; wherein the evaluation unit is arranged in a fifth interior space; wherein the three interior spaces of the three sensor elements and the interior space of the component communicate with the fifth interior space of the evaluation unit by passages in the lower housing part; wherein the three sensor elements comprises electrical wires and forward the force values via the electrical wires to the evaluation unit; wherein the optocoupler comprises at least one electrical wire and forwards the measured values via the electrical wire to the evaluation unit; and wherein the electrical wires of the three sensor elements and the electrical wire of the optocoupler are guided in the passages.

Thus, not only the sensor element and the component but also the evaluation unit is arranged within the three-part housing. This spatially compact arrangement results in a significant reduction in weight and installation size of the device. As a result, it is possible to couple the device in a mechanically stable manner to the welding gun with a relatively low coupling force which can be accomplished easily and quickly and enables autonomous operation of the device. In addition, the welding force measured is evaluated already within the device, thus, eliminating the need to transmit the force values generated by the sensor element for the welding force measured through an outside environment of the device to a spatially remote evaluation unit during which transmission to the spatially remote evaluation unit the force values might be distorted by detrimental environmental influences, thus, increasing the accuracy of the measurement of the welding force.

In a further advantageous embodiment, the device comprises an evaluation unit for evaluating the welding force measured; wherein the sensor element comprises piezoelectric material which generates electrical polarization charges under the action of the welding force; wherein the sensor element transmits the electrical polarization charges to the evaluation unit; wherein the evaluation unit comprises a charge amplifier that amplifies the electrical polarization charges to obtain direct electrical voltages; and wherein the evaluation unit has calibration data of the sensor element and the evaluation unit uses these calibration data for linearizing the direct electrical voltages.

The piezoelectric material generates force values for the welding force to be measured in the form of electrical polarization charges. The number of electrical polarization charges is proportional to the magnitude of the welding force acting. However, external influences such as variations and changes in ambient temperature may cause measurement errors in the force values. Therefore, the evaluation unit amplifies the electrical polarization charges to obtain electrical DC voltages and linearizes the electrical DC voltages using calibration data of the sensor element. Linearization reduces measurement errors in the force values. Generally and for the purposes of the present invention, the term “linearity” refers to the deviation of the force signals generated by the sensor element under the action of the welding force from the magnitude of the welding force that actually prevails. Linearity is expressed as a percentage of the full-range signal (% FS). The linearized force signals of the device exhibit high linearity of less than/equal to 1% FS, thus, representing the welding force to be measured with high accuracy. Furthermore, the measurement uncertainty of a sensor element made of piezoelectric material is small as compared to strain gauges. For the purposes of the present invention, the term “measurement uncertainty” refers to the accuracy of the agreement of sequential measurements of the welding force taken over time. The measurement uncertainty of the sensor element made of piezoelectric material is less than/equal to 0.01%, i.e. about two orders of magnitude smaller than that of strain gauges.

In a further advantageous embodiment, the evaluation unit provides the linearized electrical DC voltages in the form of analog force signals and digital force signals; wherein the evaluation unit provides the measured values as analog measurement signals or digital measurement signals; wherein the device comprises an electrical feedthrough; wherein the evaluation unit transmits the analog force signals and the digital force signals to the electrical feedthrough; wherein the evaluation unit transmits the analog measurement signals and the digital measurement signals to the electrical feedthrough; and optionally wherein analog force signals and digital force signals as well as analog measurement signals and digital measurement signals may be picked off at the electrical feedthrough from an environment outside of the device.

Thus, analog force signals and digital force signals as well as analog measurement signals and digital measurement signals optionally may be picked off at the electrical feedthrough of the device. This simplifies the measurement of the welding force and the detection of the electrical welding voltage by the device during the welding process since the device may be connected to both an analog and a digital measuring chain already present in the environment outside of the device. The force signals and measurement signals are further evaluated in the measuring chain to monitor the quality of the welding process, for example.

### BRIEF DESCRIPTION OF THE SEVERAL VIEWS OF EXEMPLARY DRAWINGS

In the following, the invention will be explained in more detail by means of exemplary embodiments thereof referring to the figures in which:

FIG. 1 shows a first embodiment of the sensing device 1 in a partial cross-sectional view cut along a transverse plane YZ looking in the direction of arrows A-A in FIG. 6 or 7, and depicted in relation to portions of a resistance welding device 2 (not shown in FIG. 6 or FIG. 7) for measuring the welding force and for detecting the electrical welding voltage during the welding process;

FIG. 2 shows a partially sectional view along a longitudinal plane XZ looking in the direction of arrows B-B in FIG. 6 or 7 for example and depicting a portion of a second embodiment of the sensing device 1 for measuring the welding force and for detecting the electrical welding voltage during the welding process of a resistance welding device 2 (not shown in FIG. 6 or FIG. 7);

FIG. 3 shows a partially sectional view along a transverse plane YZ of a portion of a third embodiment of the sensing device 1 for measuring the welding force and for detecting the electrical welding voltage during the welding process of a resistance welding device 2;

FIG. 4 shows an exploded view of a portion of the first embodiment of the sensing device 1 according to FIG. 1;

FIG. 5 shows a perspective view of a portion of an embodiment of the sensing device 1 having features according to one or more of FIGS. 1, 2, 6 and 7, but with the upper portion removed in FIG. 5 to reveal internal features that otherwise would be hidden;

FIG. 6 shows a perspective view of the first embodiment of the sensing device 1 according to FIG. 1, but flipped over from the perspective of the views of FIGS. 5 and 7; and

FIG. 7 shows a perspective view corresponding to the perspective view of FIG. 6, but mirrored by 180° in the XY-plane.

Throughout the figures, the same reference numerals denote the same objects.

### DETAILED DESCRIPTION OF EXEMPLARY EMBODIMENTS OF THE PRESENT INVENTION

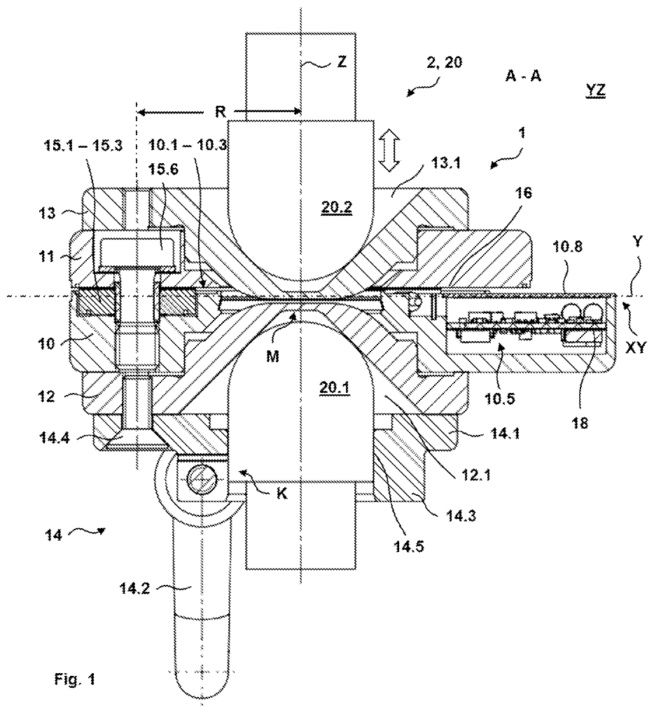

FIGS. 1 to 7 show a sensing device 1 that is configured and disposed for measuring the welding force and for detecting the electrical welding voltage during the welding process of a resistance welding device 2. The sensing device 1 and the resistance welding device 2 are described for the sake of convenient illustration in relation to a rectangular coordinate system having a longitudinal axis X, a transverse axis Y, and a vertical axis Z. The longitudinal axis X and the transverse axis Y define a horizontal plane XY. The longitudinal axis X and the vertical axis Z define a longitudinal plane XZ. The transverse axis Y and the vertical axis Z define a transverse plane YZ. In the following, the adjective “lower” will be used for an object of the sensing device 1 or the resistance welding device 2 that is arranged below the horizontal plane XY in the representations as shown in FIGS. 1 to 3, and the adjective “upper” will be used for an object of the sensing device 1 or the resistance welding device 2 that is arranged above the horizontal plane XY in the representations as shown in FIGS. 1 to 3.

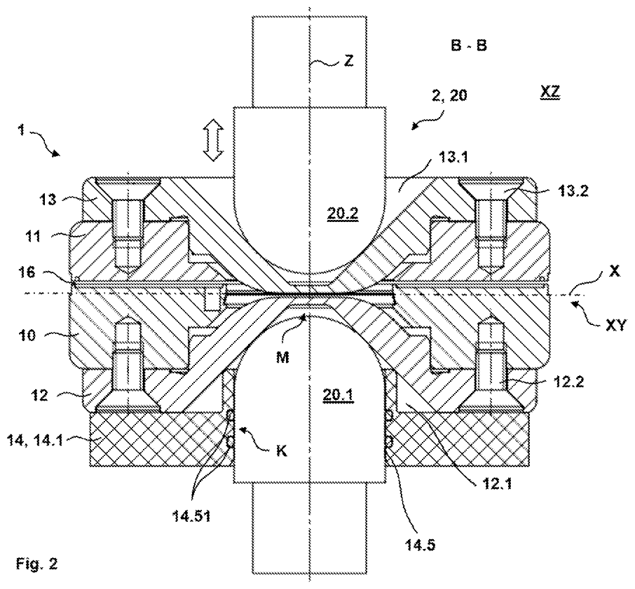

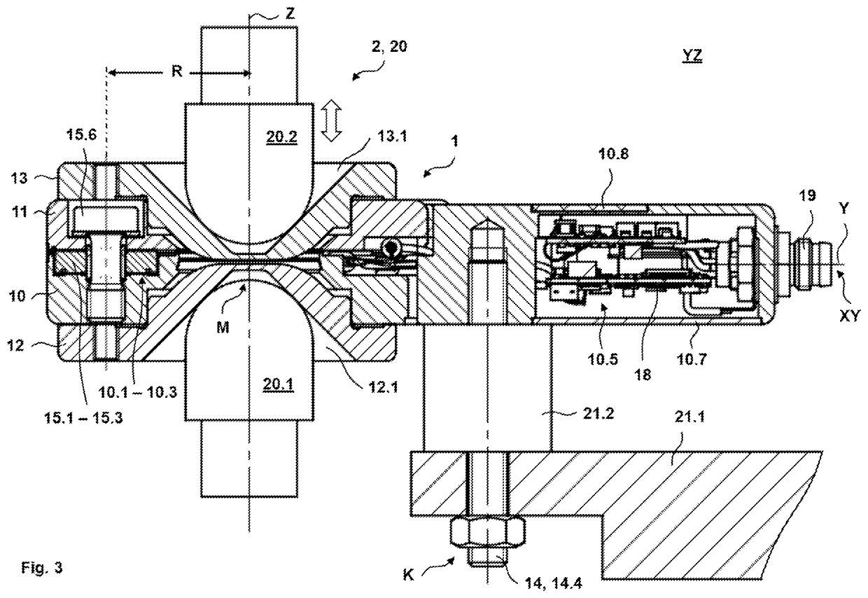

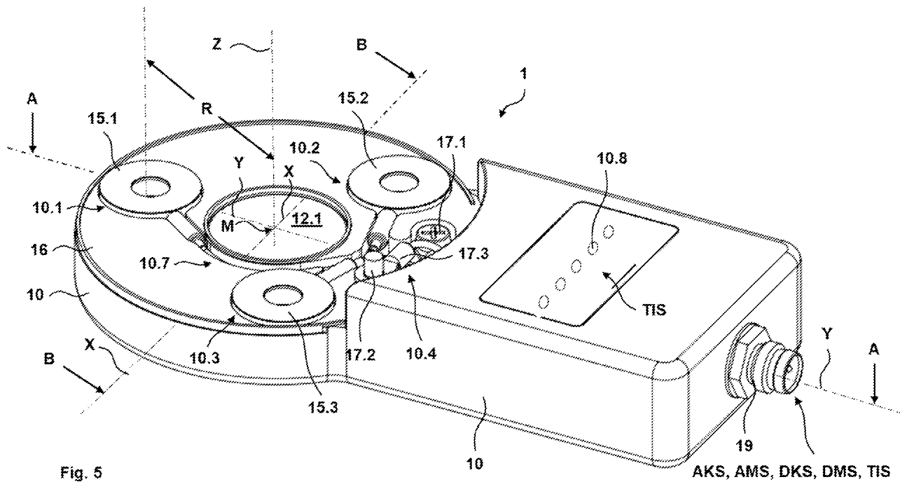

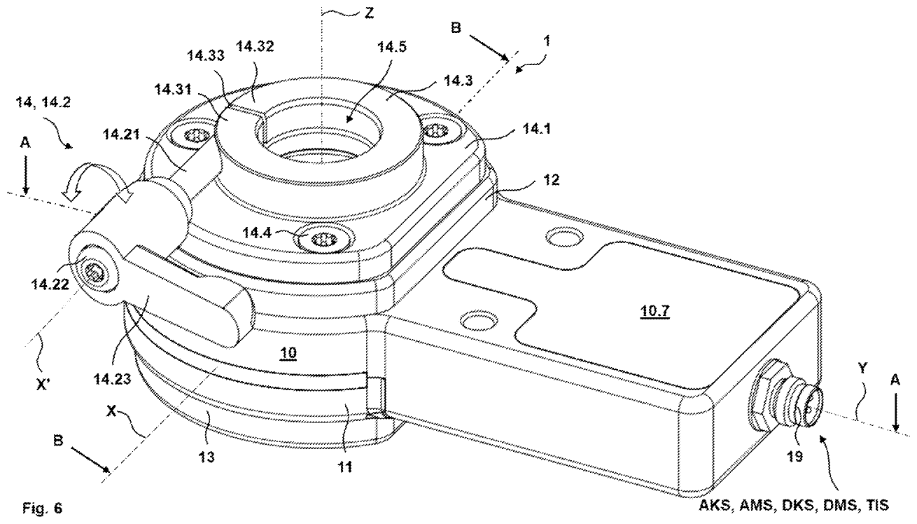

As will become readily apparent from the detailed description provided below, it bears mention that the embodiment of the coupling member 14 (described below) shown in FIGS. 1 and 6 differs from the embodiment of the coupling member 14 (described below) shown in FIG. 2. In the embodiments depicted in FIGS. 1, 2 and 5-7, the sensing device 1 is connected to a lower electrode arm 20.1 (described more fully below) of the resistance welding device 2. As described more fully below, in the embodiment depicted in FIG. 3, the sensing device 1 is coupled to a support 21.1 by means of a bearing member 21.2 of a coupling member 14. FIG. 3 therefore shows a different embodiment of the coupling member 14 than the embodiments shown in either FIG. 2 or FIG. 6. In addition, the embodiment of the electronics compartment with a plug connector 19 as shown in FIG. 3 is different than the embodiment of the electronics compartment shown in FIG. 1. In FIG. 5, the upper part has been removed in order to show the force sensors 15.1, 15.2, 15.3 (described below) that are disposed internally of the sensing device 1, and the partial view of FIG. 5 does not show any coupling member 14 at all. The embodiment of FIG. 6 is flipped with respect to the XY plane of the partial view of FIG. 5, i.e., the display means 10.8 (described below) would be on the lower side and thus is not visible in the view of FIG. 6.

The resistance welding device 2 comprises a welding gun 20 having a lower electrode arm 20.1 and an upper electrode arm 20.2. The lower electrode arm 20.1 may be arranged in a stationary manner, while the upper electrode arm 20.2 typically is arranged in a movable manner. Both electrode arms 20.1, 20.2 are made of electrically conductive material such as copper, copper alloys, etc. The welding gun 20 can be opened and closed by moving the upper electrode arm 20.2 along the vertical axis Z. The movement of the upper electrode arm 20.2 along the vertical axis Z is indicated by a double arrow in the representations shown in FIGS. 1 and 2. During a welding process, the electrode arms 20.1, 20.2 exert a welding force along the vertical axis Z and an electrical welding voltage is applied between the electrode arms 20.1, 20.2.

When the welding gun 20 is opened, the sensing device 1 can be placed at the electrode arms 20.1, 20.2. For this purpose, the sensing device 1 comprises a lower contact socket 12 and an upper contact socket 13. The two contact sockets 12, 13 are made of mechanically resistant material such as steel, tool steel, etc. The lower contact socket 12 is cylindrical in shape and internally defines a lower conical recess 12.1. The upper contact socket 13 is also cylindrical in shape and internally defines an upper conical recess 13.1. Preferably, each of the two conical recesses 12.1, 13.1 is defined by an opening angle of 45° with respect to the vertical axis Z. As schematically shown in FIGS. 1-3, each of the two conical recesses 12.1, 13.1 is configured and disposed so that it can receive a foremost tip of an electrode arm 20.1, 20.2 and center the electrode arm 20.1, 20.2 with respect to the vertical axis Z. Preferably, the sensing device 1 is placed at the electrode arms 20.1, 20.2 by placing the lower contact socket 12 on the lower electrode arm 20.1. In this way, the foremost tip of the lower electrode arm 20.1 comes to rest in the lower conical recess 12.1 in a centered manner. Closing the welding gun 20 moves the upper electrode arm into the upper conical recess 13.1 whereby it is centered.

As schematically shown in a cross-sectional view in each of FIGS. 1-3, the sensing device 1 comprises a lower housing part 10 and an upper housing part 11. The lower housing part 10 and the upper housing part 11 are made of mechanically resistant material such as steel, tool steel, etc. The lower housing part 10 and the upper housing part 11 desirably are locally cylindrical in their symmetrical shape.

The sensing device 1 comprises a lower fastening means 12.2 and an upper fastening means 13.2. The lower fastening means 12.2 and the upper fastening means 13.2 are made of mechanically resistant material such as steel, tool steel, etc. Preferably, as schematically shown in FIGS. 2, 4 and 7 for example, the lower fastening means 12.2 and the upper fastening means 13.2 are screws. The lower contact socket 12 is fastened to the outside of the lower housing part 10 by a lower fastening means 12.2. The term “outside” refers to a side of the lower housing part 10 that faces away from the upper housing part 11. The lower fastening means 12.2 in the form of a screw projects through an opening of the lower contact socket 12, and the head of the screw 12.2 rests on the outside of the lower contact socket 12, while the threaded shaft of the screw 12.2 may be screwed into threads defined in the lower housing part 10 to form a screw connection. The screw connection presses the lower contact socket 12 against the lower housing part 10. The upper contact socket 13 is fastened to the outside of the upper housing part 11 by an upper fastening means 13.2. Also here, the term “outside” refers to a side of the upper housing part 10 that faces away from the lower housing part 10. The upper fastening means 13.2 in the form of a screw projects through an opening of the upper contact socket 13, so that the head of the screw 13.2 rests on the outside of the upper contact socket 13. The threaded shaft of the screw 13.2 may be screwed into threads defined in the upper housing part 11 to form a screw connection. The screw connection presses the upper contact socket 13 against the upper housing part 11.

The sensing device 1 comprises an insulator 16. The insulator 16 is made of an electrically insulating and mechanically rigid material such as ceramics, polyimide, etc. The insulator 16 is arranged between the lower housing part 10 and the upper housing part 11 with respect to the vertical axis Z. The insulator 16 electrically insulates the lower housing part 10 from the upper housing part 11, and the lower housing part 10 and the upper housing part 11 are mechanically connected to each other via the insulator 16.

When connected to each other, the lower housing part 10 and the upper housing part 11 combine to define and enclose at least one interior space 10.1-10.5. The mechanical connection of the lower housing part 10 to the upper housing part 11 is hermetically sealed. For the purposes of the present invention, the phrase “hermetically sealed” means that air humidity, liquids and gases from the environment cannot enter the interior space 10.1-10.5. The environment is the three-dimensional space outside of the sensing device 1.

The sensing device 1 comprises at least one sensor element 15.1-15.3 and an evaluation unit 18 which are arranged in the interior space 10.1-10.5. In this way, the lower housing part 10 and the upper housing part 11 protect the sensor element 15.1-15.3 and the evaluation unit 18 from detrimental environmental influences such as contaminants (dust, moisture, etc.) and from electrical and electromagnetic interference effects in the form of electromagnetic radiation.

The sensor element 15.1-15.3 is configured and disposed so that it measures the welding force exerted by the electrode arms 20.1, 20.2 during a welding process. The sensor element 15.1-15.3 generates force values for the welding force measured. The sensor element 15.1-15.3 is arranged between the lower housing part 10 and the upper housing part 11 with respect to the vertical axis Z and lies in the horizontal plane XY. The sensor element 15.1-15.3 comprises a sensor housing made of mechanically resistant material such as steel, tool steel, etc. Preferably, the sensor element 15.1-15.3 is hollow and cylindrical in shape having two sensor end faces, two lateral sensor surfaces and a central sensor bore that defines the hollow region. The sensor end faces are configured and disposed parallel to the horizontal plane XY. A bore axis of the central sensor bore is configured and disposed parallel to the vertical axis Z.

Preferably, the sensor element 15.1-15.3 comprises piezoelectric material of a single crystal such as quartz (SiO₂), calcium gallo-germanate (Ca₃Ga₂Ge₄O₁₄ or CGG), langasite (La₃Ga₅SiO₁₄ or LGS), tourmaline, gallium orthophosphate, etc. and of piezoceramics such as lead zirconate titanate (Pb[ZrₓTi₁₋ₓ]O₃, 0≤x≤1), etc. The piezoelectric material generates force values in the form of piezoelectric charges under the action of the welding force to be measured. The piezoelectric material is oriented to have the highest sensitivity for the welding force acting along the vertical axis Z. For the purposes of the invention, the sensitivity is a ratio of the number of electrical polarization charges generated under the action of the welding force and the magnitude of the welding force acting onto the piezoelectric material. At the highest sensitivity, the piezoelectric material will generate a largest number of electrical polarization charges.

As shown in the perspective views according to FIGS. 5 and 6, the sensor element 15.1-15.3 preferably consists of a first sensor element 15.1, a second sensor element 15.2 and a third sensor element 15.3. The first sensor element 15.1 is arranged in a first interior space 10.1. The second sensor element 15.2 is arranged in a second interior space 10.2. The third sensor element 15.3 is arranged in a third interior space 10.3. Preferably, all three sensor elements 15.1-15.3 are arranged in the horizontal plane XY. Preferably, the three sensor elements 15.1-15.3 are arranged at the same radial distance R from the vertical axis Z. Preferably, the three sensor elements 15.1-15.3 are evenly spaced apart from each other at an angle of 120°. Preferably, a center of mass M of the sensing device 1 lies within the radial distance R. Preferably, a center of mass M of the device 1 as shown in FIGS. 1 to 3, 5 and 6 substantially lies on the transverse axis Y.

Preferably, the three sensor elements 15.1-15.3 are identical and measure the same welding force acting along the vertical axis Z. Preferably, each of the sensor elements 15.1-15.3 is a single-component force transducer which measures the welding force acting along the vertical axis Z as the only force component. One such single-component force transducer is type 9133C which is commercially available from the applicant and described in data sheet No. 9130C_003-418d-04.21. The single-component force transducer has an outer diameter of 16.0 mm delimited by the outer sensor lateral surface, a central sensor bore with an inner diameter of 6.1 mm, and a height of 3.5 mm between the sensor end faces. The single-component force transducer type 9133C has a sensitivity of 4 pC/N.

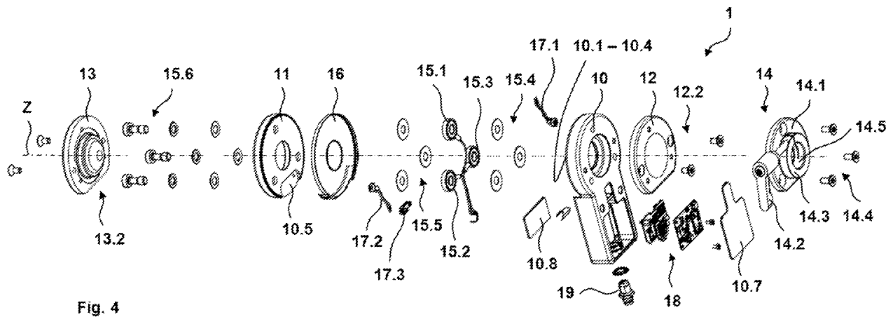

Sensing device 1 comprises a lower insulation element 15.4 and an upper insulation element 15.5, which are schematically shown in a disassemble perspective view in FIG. 4. The lower insulation element 15.4 and the upper insulation element 15.5 are disc-shaped having a central through opening. The lower insulation element 15.4 and the upper insulation element 15.5 are made of electrically insulating and mechanically rigid material such as ceramics, polyimide, etc. Each lower insulation element 15.4 is arranged between the lower housing part 10 and the respective sensor element 15.1-15.3 with respect to the vertical axis Z. Each upper insulation element 15.5 is arranged between the respective sensor element 15.1-15.3 and the upper housing part 11 with respect to the vertical axis Z. Preferably, the sensing device 1 comprises exactly one lower insulation element 15.4 and exactly one upper insulation element 15.5 for each sensor element 15.1-15.3. The respective lower insulation element 15.4 and the respective upper insulation element 15.5 electrically insulate the respective sensor element 15.1-15.3 from the lower housing part 10 and the upper housing part 11. Thus, the sensor element 15.1-15.3 is not on the same electrical potential as the electrical welding voltage of several Volts which may distort the welding force measurement.

Preferably, the sensor element 15.1-15.3 comprises pick-off electrodes. The pick-off electrodes pick off the electrical polarization charges from the piezoelectric material. The pick-off electrodes are not represented in the Figures to avoid unduly obscuring other features described herein.

Preferably, the sensing device 1 comprises at least one preloading element 15.6. To ensure that the pick-off electrodes pick off all of the electrical polarization charges generated from the piezoelectric material and no electrical polarization charges remain on the piezoelectric material which would falsify the welding force measurement, the pick-off electrodes are mechanically preloaded against the piezoelectric material by the preloading element 15.6. Mechanical preloading closes micropores between the pick-off electrodes and the piezoelectric material. Preferably, the device 1 comprises exactly one preloading element 15.6 for each sensor element 15.1-15.3. The respective preloading element 15.6 projects through the central through opening of the respective lower insulation element 15.4, the central sensor bore of the respective sensor element 15-1-15.3, the central through opening of the respective upper insulation element 15.5 and an opening in the upper housing part 11. Preferably, the preloading element 15.6 is a screw, which screw rests with a screw head on the upper housing part 11 on the outside thereof and which screw can be screwed into threads of the lower housing part 10 forming a screw connection. The screw connection presses the sensor element 15.1-15.3 against the lower housing part 10. Also here, the term “outside” refers to a side of the upper housing part 11 that faces away from the lower housing part 10.

Preferably, the sensor element 15.1-15.3 is arranged in the interior space 10.1-10.5 in the path of the main force path of the welding force. For this purpose, substantially the major fraction of the welding force acts onto the sensor element 15.1-15.3 along the vertical axis Z and only a minor fraction of the welding force acts via the insulator 16 and the preloading element 15.6. For the purposes of the present invention, the term “substantially” has the meaning of “greater than/equal to 90%”.

The sensor element 15.1-15.3 includes at least one electrical wire. The electrical wire is electrically connected to the evaluation unit 18. As schematically shown in FIGS. 1, 3, 4 and 5 for example, the sensor element 15.1-15.3 transmits the welding force measured in the form of force values by the electrical wire to the evaluation unit 18. Preferably, each of the three sensor units 15.1-15.3 comprises an electrical wire.

The device 1 comprises at least one component 17.1-17.3 schematically shown in FIGS. 4 and 5 for example. Preferably, the component 17.1-17.3 is arranged in a fourth interior space 10.4. Preferably, the component 17.1-17.3 comprises a lower electrode 17.1, an upper electrode 17.2 and an optocoupler 17.3. The lower electrode 17.1 is attached to the lower housing part 10 on the inside thereof. In this context, the term “inside” refers to a side of the upper housing part 10 that faces the lower housing part 10. The upper electrode 17.2 is attached to the inside of the upper housing part 11. In this context, the term “inside” denotes a side of the lower housing part 10 that faces the upper housing part 11. The lower electrode 17.1 and the upper electrode 17.2 are electrically connected to the optocoupler 17.3. The optocoupler 17.3 has galvanically separated inputs and outputs. The two electrodes 17.1, 17.2 detect the electrical welding voltage applied between the electrode arms 20.1, 20.2, and the optocoupler 17.3 converts the detected electrical welding voltage into measured values. The measured values at the output of the optocoupler 17.3 are electrically insulated from the electrical welding voltage at the input of the optocoupler 17.3. The measured values are electrical voltages having an amplitude that is proportional to the magnitude of the electrical welding voltage. The measured values may be digital measured values or analog measured values. The optocoupler 17.3 comprises at least one electrical wire and is connected to the evaluation unit 18 by the electrical wire and transmits the measured values to the evaluation unit 18.

The evaluation unit 18 evaluates the force values and the measured values. The evaluation unit 18 is arranged in a fifth interior space 10.5. Preferably, the three interior spaces 10.1-10.3 of the three sensor elements 15.1-15.3 and the fourth interior space 10.4 of the component 17.1-17.3 communicate with the fifth interior space 10.5 of the evaluation unit 18 by passages 10.6 in the lower housing part 10. The electrical wires of the three sensor elements 15.1-15.3 and the electrical wire of the optocoupler 17.3 are guided in the passages 10.6 of the lower housing part 10.

This spatially compact arrangement of three sensor elements 15.1-15.3, one component 17.1-17.3 and one evaluation unit 18 results in a significant reduction in the weight and installation size of the device 1. The weight of the device 1 is 0.64 kg which is less than half of that of the welding force calibration transmitter type 9831C having a weight of 1.40 kg.

The evaluation unit 18 desirably is formed by an electrical circuit with electrical and electronic components mounted on at least one printed circuit board. The lower housing part 10 comprises a cover plate 10.7 for introducing the evaluation unit 18 into the fifth interior space 10.5. The cover plate 10.7 is made of mechanically resistant material such as steel, tool steel, etc. The cover plate 10.7 is fastened to the lower housing part 10. Fastening of the cover plate 10.7 to the lower housing part 10 hermetically seals the fifth interior space 10.5. The cover plate 10.7 can be fastened to the lower housing part 10 in a detachable manner. When the fastening of the cover plate 10.7 to the lower housing part 10 is released, the fifth interior space 10.5 is accessible from the outside of the device 1 for inserting the evaluation unit 18.

The evaluation unit 18 is electrically insulated from the lower housing part 10 and the upper housing part 11. Thus, the evaluation unit 18 is not on the same potential as the electrical welding voltage of several V, which may falsify the evaluation of the welding force measured and the evaluation of the electrical welding voltage measured.

Preferably, the evaluation unit 18 comprises a charge amplifier unit that amplifies the force values transmitted in the form of electrical polarization charges by the electrical wires to give electrical DC voltages. The electrical DC voltages are analog force signals AKS of the evaluation unit 18. Preferably, the evaluation unit 18 digitizes the analog force signals AKS to give digital force signals DKS. Preferably, the evaluation unit 18 comprises calibration data of the sensor element 15.1-15.3 and the evaluation unit 18 is configured to use these calibration data for linearizing the force signals. The evaluation unit 18 may linearize analog force signals AKS or digital force signals DKS. Preferably, the calibration data is a calibration curve with coefficients of a polynomial function.

Preferably, the evaluation unit 18 provides measured values of the electrical welding voltage detected during the welding process as analog measurement signals AMS or digital measurement signals DMS.

In the embodiments according to FIGS. 3 to 7, the device 1 comprises an electrical feedthrough 19. The electrical feedthrough 19 is fastened to the lower housing part 10. The fastening of the electrical feedthrough 19 to the lower housing part 10 is hermetically sealed. Preferably, the electrical feedthrough 19 is locally arranged within the fifth interior space 10.5. The electrical feedthrough 19 is electrically connected to the evaluation unit 18. The force signals and the measurement signals can be transmitted from the evaluation unit 18 out of the fifth interior space 10.5 to the outside of the device 1 by the electrical feedthrough 19.

Preferably, the electrical feedthrough 19 optionally carries analog force signals AKS and digital force signals DKS. Preferably, the analog force signals AKS and digital force signals DKS carried by the electrical feedthrough 19 are linearized. Preferably, the electrical feedthrough 19 optionally carries analog measurement signals AMS and digital measurement signals DMS. Preferably, the electrical feedthrough 19 has four electrical contacts. Optionally, the analog force signals AKS and the analog measurement signals AMS as well as the digital force signals DKZ and the digital measurement signals DMS are applied to these four contacts. In addition, technical information signals TIS such as a type name of the sensing device 1, a serial number of the sensing device 1, a website of the manufacturer of the sensing device 1, a calibration date of the sensor element 15.1-15.3, a measuring range of the sensor element 15.1-15.3, a sensitivity of the sensor element 15.1-15.3, an operational state of the sensing device 1, etc. may be read out from the evaluation unit 18 by the electrical feedthrough 19. The technical information signals TIS simplify the measurement of the welding force since the technical information signals TIS may be read out by a measuring chain situated in the environment and simplify further evaluation of the force signals and measurement signals in the measuring chain. An electrical supply voltage may be supplied to the evaluation unit 18 by the electrical feedthrough 19.

The electrical feedthrough 19 is electrically insulated from the lower housing part 10 and the upper housing part 11. Thus, the electrical feedthrough 19 is not on the same potential as the electrical welding voltage of several V, which may falsify the output of the force signals and the measurement signals.

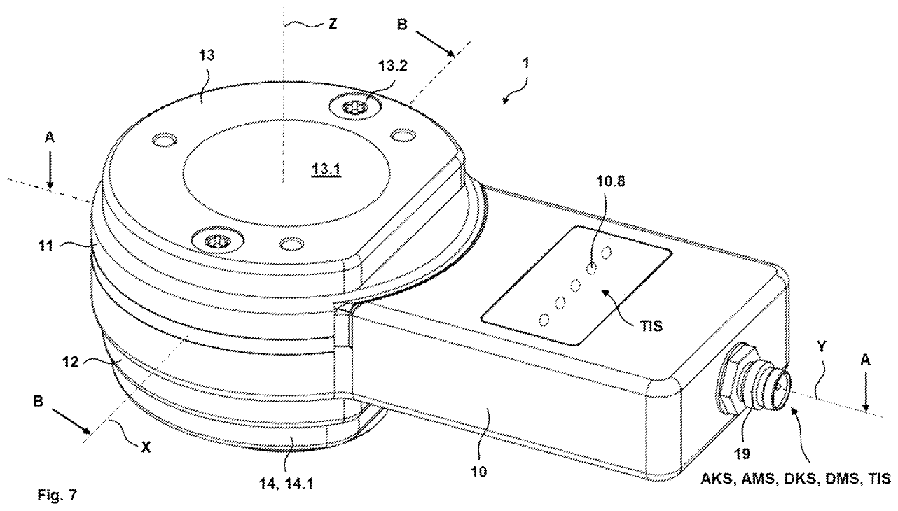

Although the sensing device 1 is able to autonomously measure the welding force and the electrical welding voltage, the operating state of the sensing device 1 still has to be monitored. For this purpose, the sensing device 1 comprises a display means 10.8. The display means 10.8 is attached to the lower housing part 10. The display means 10.8 is attached to the lower housing part 10 in a hermetically sealed manner. The display means 10.8 desirably comprises at least one light or screen. Technical information signals TIS such as an operating state of the sensing device 1, etc., can be visually displayed on the display means 10.8 to a human operator outside of the sensing device 1. According to FIGS. 5 and 7, the display means 10.8 comprises five lights. For visually indicating the technical information signals TIS, the lights may light up in different colors, they may flash for different lengths of time, etc. The operating state of the device 1 may be “ready”, “not ready”, etc. The display means 10.8 is easily visible for the human operator even from a distance of 1 m or 2 m and enables autonomous operation of the sensing device 1. As a result, interruptions of the operating state of the sensing device 1 may be detected easily and quickly and corrected by the human operator which in turn minimizes the time required for measuring the welding force and the electrical welding voltage.

The sensing device 1 comprises a coupling member 14 that is configured and disposed to connect the sensing device to the arms 20.1, 20.2 of the resistance welding device 2 in a manner that permits detection of the welding force and welding voltage between the arms 20.1, 20.2. In the first embodiment according to FIG. 1, the coupling member 14 is configured as a clamp coupling. In the second embodiment according to FIG. 2, the coupling member 14 is configured as a form-locking coupling. In the third embodiment according to FIG. 3, the coupling member 14 is configured as a force-locking coupling. The coupling member 14 desirably is made of mechanically resistant material such as steel, tool steel, aluminum, thermoplastic, etc.

In the first embodiment according to FIG. 1, the coupling member 14 comprises a coupling body 14.1 and at least one further fastening member 14.4. The coupling body 14.1 is attached to the outside of the lower contact socket 12 by the further coupling member 14.4. The term “outside” refers to a side of the lower contact socket 12 that faces away from the lower housing part 10. Preferably, the further fastening member 14.4 is a screw, which screw projects through an opening in the coupling body 14.1, which screw rests on the coupling body 14.1 on the outside thereof with a screw head, and which screw can be screwed into threads of the lower contact socket 12 and forms a screw connection. The screw connection presses the coupling body 14.1 against the lower contact socket 12.

In the first embodiment according to FIG. 1, the coupling member 14 comprises a clamping member 14.3. The clamping member 14.3 is integrally formed with the coupling body 14.1. Preferably, the clamping member 14.3 is formed to the outside of the coupling body 14.1. The term “outside” refers to a side of the coupling body 14.1 that faces away from the lower contact socket 12. The coupling body 14.1 and the clamping member 14.3 are hollow-cylindrical in shape.

In the first embodiment according to FIG. 1, the coupling member 14 comprises a coupling opening 14.5. The coupling opening 14.5 extends through the coupling body 14.1 and the clamping member 14.3 along the vertical axis Z. The coupling opening 14.5 communicates with the conical recess 12.1 of the lower contact socket 12. Thus, the device 1 can be placed at the electrode arms 20.1, 20.2 by placing the coupling member 14 on the lower electrode arm 20.1 in such a way that the lower electrode arm 20.1 protrudes through the coupling opening 14.5 and the foremost tip of the lower electrode arm 20.1 comes to rest in the lower conical recess 12.1 of the lower contact socket 12 in a centered manner. The coupling opening 14.5 has a diameter, which diameter is equal to the outer diameter of the lower electrode arm 20.1. The diameter of the coupling opening 14.5 and the outer diameter of the lower electrode arm 20.1 have a small mechanical play of preferably 0.1 mm.

In the first embodiment according to FIG. 1, the clamping member 14.3 radially surrounds the coupling opening 14.5 arranged in the coupling body 14.1. The clamping member 14.3 has a first clamping member end 14.31 and a second clamping member end 14.32. The two clamping member ends 14.31, 14.32 are spaced apart from each other by a gap 14.33. In the perspective view according to FIG. 6, the gap 14.33 has a width of preferably 1 mm along the longitudinal axis X.

In the first embodiment according to FIG. 1, the coupling member 14 comprises a clamping member 14.2. The clamping member 14.2 is arranged at the clamping member 14.3. The clamping member 14.2 comprises a bushing member 14.21, a screw member 14.22 and a handle member 14.23. The bushing member 14.21 is hollow cylindrical in shape having a centrally disposed hollow axis designated X′ as schematically shown in FIG. 6. In the perspective view according to FIG. 6, the bushing member 14.21 extends along the hollow axis X′, which is parallel to the longitudinal axis X. The bushing member 14.21 is attached to the first clamping member end 14.31. The screw member 14.22 is locally arranged in the hollow axis and is held in the bushing member 14.21 by form-locking. The screw member 14.22 has a first end and a second end. The handle member 14.23 is attached to the first end of the screw member 14.22. The screw member 14.22 may be rotated about the longitudinal axis X by the handle member 14.23. In the perspective view according to FIG. 6, rotatability of the screw member 14.22 about the hollow axis X′ is indicated by a curved double arrow. The screw member 14.22 comprises an external thread at the second end. The external thread at the second end of the screw member 14.22 may be screwed into threads in the second clamping member end 14.32 by rotation about the hollow axis X′, and forms a screw connection. By rotating the screw member 14.22 in a first direction about the hollow axis X′, the screw member threads into the second clamping member end 14.32. Since the screw member 14.22 is retained in the bushing member 14.21 and thus also in the first clamping member end 14.31 to which the bushing member 14.21 is attached, the rotation reduces the width of the gap 14.33 in the direction of the hollow axis X′. The reduction in the width of the gap 14.33 is greater than the mechanical play between the diameter of the coupling opening 14.5 and the outer diameter of the lower electrode arm 20.1 whereby, when the device 1 is placed at the electrode arm 20.1, 20.2 and the lower electrode arm 20.1 protrudes through the coupling opening 14.5, the reduction in the width of the gap 14.33 clamps the lower electrode arm 20.1 into the clamping member 14.3 and exerts a coupling force K onto the lower electrode arm 20.1. Thus, the coupling member 14 and the lower electrode arm 20.1 achieve coupling by clamping. The coupling force K is high enough to couple the sensing device 1 to the welding gun 2 in a mechanically stable manner. For the purposes of the present invention, the phrase “coupling in a mechanically stable manner” means that during operation of the resistance welding device 2 the sensing device 1 is immovably coupled to the lower electrode arm 20.1.

In the second embodiment according to FIG. 2 the coupling member 14 also comprises a coupling body 14.1. The coupling body 14.1 is arranged at the lower contact socket 12 on the outside thereof. The term “outside” refers to a side of the lower contact socket 12 that faces away from the lower housing part 10. Preferably, the coupling body 14.1 is located in the lower conical recess 12.1 of the lower contact socket 12.

The coupling body 14.1 of the second embodiment according to FIG. 2 is also hollow cylindrical in shape and comprises a coupling opening 14.5. The coupling opening 14.5 extends through the coupling body 14.1 along the vertical axis Z. The coupling opening 14.5 communicates with the conical recess 12.1 of the lower contact socket 12. The coupling opening 14.5 has a diameter, which diameter is equal to the outer diameter of the lower electrode arm 20.1. As schematically shown in FIG. 2, a retaining member 14.51 is arranged in the coupling opening 14.5. The retaining member 14.51 is ring-shaped and arranged in a circumferentially extending groove that is defined beneath the cylindrical surface that defines the coupling opening 14.5. The retaining member 14.51 desirably is made of elastic material such as rubber, perfluoro rubber, etc. Preferably, two retaining members 14.51 are arranged in the coupling opening 14.5. Each respective retaining member 14.51 arranged in each respective groove slightly projects into the coupling opening 14.5 in a radial direction. Thus, the sensing device 1 can be placed at the electrode arms 20.1, 20.2 by placing the coupling member 14 on the lower electrode arm 20.1 in such a way that the lower electrode arm 20.1 projects through the coupling opening 14.5 and the foremost tip of the lower electrode arm 20.1 comes to rest in the lower conical recess 12.1 of the lower contact socket 12 in a centered manner. In this way, the retaining member 14.51 arranged in the groove is radially compressed by the lower electrode arm 20.1. Thus, the coupling member 14 and the lower electrode arm 20.1 achieve coupling by form-locking. The compressed retaining member 14.51 exerts a coupling force K onto the lower electrode arm 20.1.

In the third embodiment according to FIG. 3, the coupling member 14 only consists of a further fastening member 14.4. The resistance welding device 2 comprises a support 21.1 and a bearing member 21.2. The support 21.1 is arranged close to the two electrode arms 20.1, 20.2 so that the sensing device 1, when placed at the two electrode arms 20.1, 20.2, can be mechanically coupled to the support 21.1. The bearing member 21.2 is preferably made of elastic material such as rubber, natural rubber, etc. and elastically supports the device 1 on the support 21.1. Vibrations are dampened by the bearing member 21.2 and cannot be transmitted from the resistance welding device 2 to the sensing device 1 and falsify the measurement of the welding force and the detection of the electrical welding voltage during the welding process. Furthermore, the sensing device 1 is electrically insulated from the electrical potential of the resistance welding device 2 by the bearing member 21.2 so that variations in the electrical potential of the resistance welding device 2 cannot affect the measurement of the welding force and the detection of the electrical welding voltage during the welding process. Preferably, the further fastening member 14.4 includes two screws, and desirably only two. The support 21.1 comprises two through holes, one configured and disposed to receive a respective one of the two screws. Each screw projects through a through hole of the support 21.1. Each screw rests with a screw head on the outside of the support 21.1. And each screw may be screwed into threads of the lower housing part 10, thus, forming a screw connection. The term “outside” refers to a side of the support 21.1 that faces away from the lower housing part 10. The screw connection of the further fastening member 14.4 presses the lower housing part 10 against the support 21. Thus, the coupling member 14 mechanically couples the lower housing part 10 and the support 21.1 by force-locking.

### LIST OF REFERENCE NUMERALS

1 sensing device
2 resistance welding device
10 lower housing part
10.1 first interior space
10.2 second interior space
10.3 third interior space
10.4 fourth interior space
10.5 fifth interior space
10.6 passage
10.7 cover plate
10.8 display means
11 upper housing part
12 lower contact socket
12.1 lower conical recess
12.2 lower fastening member
13 upper contact socket
13.1 upper conical recess
13.2 upper fastening member
14 coupling member
14.1 coupling body
14.2 clamping element
14.21 bushing member
14.22 screw member
14.23 handle member
14.3 clamping member
14.31 first clamping member end
14.32 second clamping member end
14.33 gap
14.4 further fastening member
14.5 coupling opening
14.51 retaining member
15.1 first sensor element
15.2 second sensor element
15.3 third sensor element
15.4 lower insulation element
15.5 upper insulation element
15.6 preloading element
16 insulator
17.1 lower electrode
17.2 upper electrode
17.3 optocoupler
18 evaluation unit
19 electrical feedthrough
20 welding gun
20.1 lower electrode arm
20.2 upper electrode arm
21.1 support
21.2 bearing member
AKS analog force signals
DKS digital force signals
AMS analog measurement signals
DMS digital measurement signals
K coupling force
M center of mass
R radial distance
TIS technical information signals
X longitudinal axis
XY horizontal plane
XZ longitudinal plane
Y transverse axis
YZ transverse plane
Z vertical axis

What is claimed is:

1. A sensing device for measuring a welding force and for detecting a welding voltage during a welding process of a resistance welding device that includes a welding gun with a first electrode arm and a second electrode arm disposed opposite the first electrode arm; the device comprising:
a housing part;
a first contact socket carried by the housing part and configured to receive the first electrode arm;
a second contact socket carried by the housing part and configured to receive the second electrode arm;
a first sensor element configured and disposed between the first contact socket and the second contact socket for measuring the welding force applied by the first and second electrode arms of the welding gun during the welding process;
a component carried by the housing part and configured and disposed for detecting the welding voltage during the welding process; and
a coupling member carried by the housing part and configured and disposed to mechanically couple to the resistance welding device when the sensing device is placed at the electrode arms.

2. The sensing device according to claim 1, wherein the two electrode arms are symmetrically aligned with and elongate along a vertical axis and consist of a lower electrode arm and an upper electrode arm disposed above the lower electrode arm;
wherein the two contact sockets consist of a lower contact socket and an upper contact socket;
wherein the lower contact socket has a lower conical recess that is configured to receive and center a foremost tip of the lower electrode arm disposed closest to the upper electrode arm with respect to the vertical axis when the device is disposed at the electrode arms; and
wherein, for mechanical coupling of the sensing device and the resistance welding device, the coupling member is configured and disposed to exert a coupling force onto the resistance welding device.

3. The sensing device according to claim 2, wherein the coupling member comprises a coupling body that is attached to the lower contact socket on the outside thereof;
wherein the coupling body comprises a coupling opening that extends through the coupling body along the vertical axis and communicates with the lower conical recess;
wherein the coupling opening is configured and disposed so that the lower electrode arm projects through the coupling opening when the sensing device is placed at the electrode arms; and
wherein, for mechanical coupling of the sensing device and the resistance welding device, the coupling member is configured and disposed to exert the coupling force in the coupling opening onto the lower electrode arm.

4. The sensing device according to claim 3, wherein the coupling member comprises a clamping member that surrounds the coupling opening in a radial direction with respect to the vertical axis;
wherein the clamping member defines a first clamping member end and a second clamping member end, which first and second clamping member ends are spaced apart from each other by a width of a gap; and
wherein a reduction in the width of the gap exerts the coupling force onto the lower electrode arm.

5. The sensing device according to claim 4, wherein the coupling member comprises a clamping element that is arranged at the clamping member;
wherein the clamping element comprises a bushing member and a screw member;
wherein the bushing member is fastened to the first clamping member end and holds the screw member; and
wherein the screw member is screwed into the second clamping member end in a manner so that rotation of the screw member changes the width of the gap.

6. The sensing device according to claim 3, further comprising:
a retaining member disposed in the coupling opening and configured so that when the sensing device is placed at the electrode arms with the lower electrode arm protruding through the coupling opening and compressing the retaining member, then the compressed retaining member exerts the coupling force onto the lower electrode arm.

7. The sensing device according to claim 2, wherein the resistance welding device comprises a support and the coupling member further includes a further fastening member that is configured and disposed to exert the coupling force onto the support for the mechanical coupling of the sensing device and the support of the resistance welding device when the sensing device is placed at the electrode arms.

8. The sensing device according to claim 1, further comprising:
a lower housing part;
an upper housing part disposed spaced from the lower housing part along the vertical axis; and
an insulator disposed between the lower housing part and the upper housing part;
wherein the two contact sockets comprise a lower contact socket and an upper contact socket;
wherein the lower contact socket is fastened on the outside of the lower housing part;
wherein the upper contact socket is fastened on the outside of the upper housing part;
wherein the insulator electrically insulates the lower housing part from the upper housing part;
wherein the lower housing part and the upper housing part are mechanically connected to each other by the insulator;
wherein the lower housing part and the upper housing part, when connected, enclose at least one interior space; and
wherein the sensor element and the component are arranged in said interior space.

9. The sensing device according to claim 8, wherein the welding force of the resistance welding device is aligned along a main force path, and wherein the sensor element is arranged in the interior space in the main force path of the welding force.

10. The sensing device according to claim 8, further comprising:
a second sensor element and a third sensor element;
wherein each of the first sensor element, the second sensor element and the third sensor element includes an identical single-component force transducer, which is configured to measure the same welding force acting along the vertical axis that is disposed normal to a longitudinal axis; and
wherein the three sensor elements generate force values for the welding force measured.

11. The sensing device according to claim 10, wherein the first sensor element is arranged in a first interior space, the second sensor element is arranged in a second interior space and the third sensor element is arranged in a third interior space;
wherein the three sensor elements lie in a horizontal plane perpendicular to a vertical axis;
wherein the three sensor elements are arranged at an equal radial distance from the vertical axis; and
wherein the three sensor elements are arranged evenly spaced apart from each other at an angle of 120°.

12. The sensing device according to claim 10, wherein the component is arranged in a fourth interior space;
wherein the component comprises a lower electrode, an upper electrode and an optocoupler;
wherein the lower housing part defines an inside and the lower electrode is fastened to the inside of the lower housing part;
wherein the upper housing part defines an inside and the upper electrode is fastened to the inside of the upper housing part; and
wherein the optocoupler is configured to detect an electrical welding voltage acting between the lower electrode and the upper electrode and to convert the electrical welding voltage into measured values.

13. The sensing device according to claim 12, further comprising:
an evaluation unit for configured for evaluating the force values;
wherein the evaluation unit is arranged in a fifth interior space;
wherein passages are defined in the lower housing part;
wherein the respective three interior spaces of each of the respective three sensor elements and the respective interior space of each of the respective components communicates with the fifth interior space of the evaluation unit by the passages defined in the lower housing part;
wherein the three sensor elements have electrical wires and are configured to transmit the force values to the evaluation unit by the electrical wires;
wherein the optocoupler has at least one electrical wire and is configured to transmit the measured values to the evaluation unit by the at least one electrical wire; and
wherein the electrical wires of the three sensor elements and the at least one electrical wire of the optocoupler are guided in the passages.

14. The sensing device according to claim 12, further comprising:
an evaluation unit configured for evaluating the welding force measured;
wherein the sensor element includes piezoelectric material that generates electrical polarization charges under the action of the welding force;
wherein the sensor element is configured to transmit the electrical polarization charges to the evaluation unit;
wherein the evaluation unit includes a charge amplifier that is configured to amplify the electrical polarization charges to give direct electrical voltages; and
wherein the evaluation unit is configured to access calibration data of the sensor element and use said calibration data for linearizing the direct electrical voltages.

15. The sensing device according to claim 14, further comprising:
an electrical feedthrough;
wherein the evaluation unit is configured to provide the linearized electrical DC voltages as analog force signals and as digital force signals;
wherein the evaluation unit is configured to provide the measured values as analog measurement signals or digital measurement signals;
wherein the evaluation unit is configured to transmit the analog force signals and the digital force signals to the electrical feedthrough;
wherein the evaluation unit is configured to transmit the analog measurement signals and the digital measurement signals to the electrical feedthrough; and
wherein the analog force signals and digital force signals as well as analog measurement signals and digital measurement signals can be picked off from an environment outside of the device at said electrical feedthrough.

16. The sensing device according to claim 1, further comprising:
an optocoupler configured to detect an electrical welding voltage;
wherein the housing part defines a lower housing part and an upper housing part disposed spaced from the lower housing part along the vertical axis;
an insulator disposed between the lower housing part and the upper housing part and mechanically connecting the lower housing part and the upper housing part to each other in a manner defining an interior space between the lower housing part and the upper housing part;
wherein the first contact socket defines a lower contact socket and an upper contact socket;
wherein the lower housing part defines an outside, and the lower contact socket is fastened on the outside of the lower housing part;
wherein the upper housing part defines an outside, and the upper contact socket is fastened on the outside of the upper housing part;
wherein the insulator electrically insulates the lower housing part from the upper housing part;
wherein the first sensor element, the optocoupler and the component are arranged in said interior space;
wherein the component includes a lower electrode and an upper electrode;
wherein the lower housing part defines an inside, and the lower electrode is fastened to the inside of the lower housing part;
wherein the upper housing part defines an inside, and the upper electrode is fastened to the inside of the upper housing part; and
wherein the optocoupler is configured to act between the lower electrode and the upper electrode and to convert an electrical welding voltage into a measured value.
